(19) United States
(12) Patent Application Publication
(10) Pub. No.: US 2006/0172755 A1
(43) Pub. Date: Aug. 3, 2006

(54) System and method for push-to-talk image communications in a mobile communication terminal

(75) Inventor: Joon-Gil Park, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/345,747

(22) Filed: Feb. 2, 2006

(30) Foreign Application Priority Data
Feb. 2, 2005 (KR) 2005-9714

(51) Int. Cl. H04B 7/00

(52) U.S. Cl. 455/518

(57) ABSTRACT

An image communication system and a method, capable of a group-call pictorial communication using a mobile communication terminal. The system provides mobile subscribers with Push-To-Talk (PTT) picture communication with one or more designated destination parties, converting a set of voice data and image data to PTT Internet Protocol packets and transferring the packet data through the PTT communication.

### PRIORITY

This application claims priority under 35 U.S.C. § 119 from an application entitled “A Method And System For Push-to-Talk Image Communications In A Mobile Communication Terminal” filed in the Korean Industrial Property Office on Feb. 2, 2005 and assigned Application Serial No. 2005-9714, the contents of which are incorporated herein by reference.

### BACKGROUND OF THE INVENTION

1. Field of the Invention

The present invention relates generally to an image communications system using a mobile communication terminal, and in particular, to a method and system for push-to-talk (PTT) image communications using such a mobile communication terminal.

2. Description of the Related Art

Recently, 3^{rd} generation mobile communication network systems such as Universal Mobile Telecommunications Systems (UMTS) have more commonly come into use, allowing their mobile subscribers to enjoy greater extended functions of communication services than ever before. A typical 3^{rd} generation mobile communication system may be a so-called image or pictorial communication service using the mobile terminal.

A typical image communications service enables its users to make pictorial communications on their mobile phones on conversational basis, using an Moving Picture Experts Group 4 (MPEG4) or H.263 standard CODEC multiplexing video data and audio data. Therein the image communications service utilizes a Circuit Switch (CS) or Circuit Switch Data (CSD) network and data for image communications are transferred to a destination party in a frame unit used in the CS or CSD. This image communication system has not been used in a packet switching (PS) network due to its variable bandwidth in Internet Protocol (IP) network. Moreover, such a PS network cannot be used for usual image communication because there often arises some transmission delay during its data transmission. Hence, the image communication could be implemented in one-to-one call mode only using either CS or CSD network. Furthermore, such an independent use of network resources will increase cost comparatively in implementation of image communication.

Push-to-talk (PTT) communication, now prevailing in the market, started with a 2^{nd} or 2.5^{th} generation of mobile communication system. PTT has opened a new stage of profit making business for many network providers, by providing a user with a group call service capable of calling a multiplicity of subscribers at the same time. The PTT communication service makes it possible to establish a virtual connection to a particular group specified by the user and attempt a calling for multiple subscribers simultaneously, using a session initiation protocol (SIP). That is to say, the PTT communication service enables a given subscriber to communicate with one or more subscribers in a specified group simultaneously, by means of voice data transmission. Using this PTT communication system in a mobile communication network, it would be possible for many subscribers to participate in a group call at the same time. Further, the system allows to effect a smoothly functioning group call between multiple remote subscribers even in case where subscriber terminals attending the group call are located in many different cell locations far away from each other, thereby covering even a countrywide network with PTT communication. This kind of group call service may be utilized as a conference call in between more than two subscribers. For activation of PTT communication system, a given subscriber pushes a PTT enable button disposed in a user's mobile terminal to transmit voice data to a multiplicity of destination terminals and then, the destination terminals are allowed to receive the voice data using dedicated broadcast channels. It is known that the PTT communication system is generally designed to communicate with IP-packeted data transmission and utilize a PS network linked to a mobile communication network. However, one of the disadvantages in PTT communication system is that it was originally designed to support only the voice communication.

### SUMMARY OF THE INVENTION

Therefore, it is an object of the present invention to provide an image communications system and a method for the same capable of a group-call pictorial communication with one or more mobile subscribers using a mobile communication terminal. In another aspect of the invention, the present invention aims to provide such an image communication system and a method for the same capable of a group-call pictorial communication with a comparatively low production cost.

To achieve the above and other objects of the present invention, there is provided a method of performing push-to-talk (PTT) image communications using a mobile communication terminal having at least one camera module, wherein the method includes making access to a push-to-talk (PTT) server upon receipt of a request from a user of the mobile communication terminal; activating the camera module and a microphone unit upon input of a PTT call function key to respectively produce picture data and voice data; multiplexing the picture data and the voice data to generate a set of moving picture data; and converting the moving picture data to push-to-talk Internet Protocol (PTT IP) packets and transferring the packets to the PTT server.

Preferably, the method may further include receiving a given PTT IP packet while accessing the PTT server; converting the PTT IP packet to a moving picture data; demultiplexing the moving picture data to respectively separate a series of voice data and picture data; and reproducing the voice data in synchronization to be output to a speaker and simultaneously reproducing the picture data in synchronization to be output to a display unit.

According to a second aspect of the present invention, there is provided a push-to-talk (PTT) image communication system using a mobile communication terminal. The system includes a PTT server for transmitting a PTT IP packet received to a destination mobile terminal; and the mobile communication terminal. The mobile communication terminal includes a controller for making access to the PTT server upon receipt of a request from a user of the mobile communication terminal, activating the camera module and a microphone unit upon input of a PTT call function key to thereby produce picture data and voice data, multiplexing the produced picture data and the voice data to generate a set of moving picture data, and converting the moving picture data to the PTT IP packets and transferring the packets to the PTT server.

Preferably, according to the PTT image communication system of the present invention, the mobile communication terminal may be configured to convert a given PTT IP packet received to a moving picture data while accessing the PTT server, to demultiplex the moving picture data to respectively separate a series of voice data and picture data, and to reproduce the voice data in synchronization to be output to a speaker as well as reproduce the picture data in synchronization to be output to a display unit.

### BRIEF DESCRIPTION OF THE DRAWINGS

The above and other objects, features and advantages of the present invention will become more apparent from the following detailed description when taken in conjunction with the accompanying drawings in which:

FIG. 1 schematically shows a system configuration of a PTT service system using a mobile communication terminal according to the present invention;

FIG. 2 schematically shows a block diagram for a mobile communication terminal according to the present invention;

FIG. 3 shows a flow chart diagram of the operation sequence for a PTT IP packet transmission in the mobile communication terminal according to a preferred embodiment of the present invention; and

FIG. 4 shows a flow chart diagram of the operation sequence for a PTT IP packet reception in the mobile communication terminal according to the present invention.

### DETAILED DESCRIPTION OF THE PREFERRED EMBODIMENTS

A preferred embodiment of the present invention will be described hereinafter with reference to the accompanying drawings. In the following description, the same drawing reference numerals are used for the same elements, even in different drawings. The detailed construction and circuit elements are described only to assist in a comprehensive understanding of the invention. Thus, it will be apparent that the present invention can be carried out without these particulars. Also, well-known functions or constructions are not described in detail since they would unnecessarily obscure the invention.

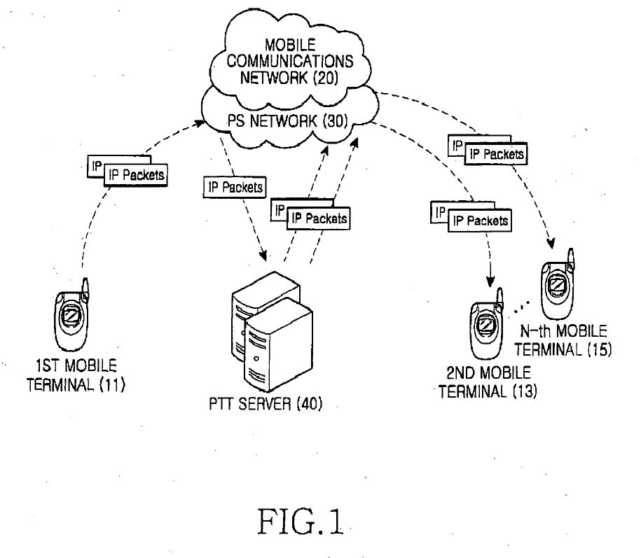

Referring now to FIG. 1, a system configuration is described for a PTT communication service using a mobile communication terminal to which the present invention is applied. As shown in FIG. 1, the PTT system has a plurality of mobile communication terminals as indicated by 11, 13, and 15, a mobile communication network 20, a packet switching (PS) network 30 and a PTT server 40. The mobile communication network 20 serves as a path for communicating with the mobile communication terminals such as 11, 13 and 15 and the PTT server 30. The network may be configured with one of known 3rd generation mobile communication systems such as a Code Division Multiple Access (CDMA) 2000, Wideband Code Division Multiple Access/Universal Mobile Telecommunication System (WCDMA/UMTS), General Packet Radio System (GPRS) and CDMA 2000 1x Evolution Data and Video (EV-DV) system, depending upon preferred embodiments of the invention. The mobile communication network 20 is configured to operate in association with the PS network 30 and further with a Wireless Local Area Network (WLAN), not shown in the drawing.

The PS network 30, preferably configured of a conventional wired network, serves to transfer packet data of a fixed size, wherein not only most of computer communications but also the PTT communications are carried out via this PS network. The PTT server 40 is a kind of Session Initiation Protocol (SIP) based device for multi-media session control, in particular, for carrying out registration and authentication of a multi-media subscriber and download of a subscriber profile. The subscriber profile is configured to correspond to a given mobile communication terminal with a PTT access number of the mobile communication terminal, or a list of destination parties for a group call. The PTT server 40 controls establishing a PTT session between an originating terminal and a number of designated terminals of the destination terminals for a group call. Once the PTT session has been set, then the PTT server 40 also controls broadcasting voice data received from the originating terminal to those designated terminals via the PS network 30 and mobile communication network 20.

In a preferred embodiment of the invention as shown in FIG. 1, the mobile communication terminals include an n number of mobile terminals, for instance, a first terminal 11, a second terminal 13 and an n-th terminal 15. The mobile terminals are divided into a plurality of groups depending upon a PTT user's selection, each group having a plurality of mobile terminals. With this construction, a communication link could be established via the mobile communication network 20 between the terminals belonging to a respective group, thereby enabling a group call between multiple called parties.

The PTT communication system as described above performs a sequence of PTT image communication according to the present invention, as follows. A given originating mobile communication terminal makes an access to the PTT server 40. Once the PTT server 40 has detected such an access from the given originating mobile terminal, it controls transmitting to the originating mobile terminal the information relating to mobile terminals presently accessed to the PTT server 40 among the mobile communication terminals designated for a group call with the originating mobile terminal. Then, if the PTT call key input has been detected, the given originating mobile terminal controls activation of a microphone and a camera module to produce voice and picture data. Subsequently, the originating mobile terminal multiplexes the produced voice and picture data to generate a set of moving picture data, and converts the moving picture data to PTT IP packets for transmission to the PTT server 40 together with providing terminal information designating its destination. Here, the destination terminal is a designated mobile terminal, to which a user for the given originating mobile terminal intends to make a PTT image communication available, selects from among the plurality of mobile terminals for a group call currently accessed to the PTT server 40. The PTT server that received the PTT IP packets sent via the mobile communication network 20 and the packet switching (PS) network 30, controls transmitting the PTT IP packets to the destination mobile terminal. The mobile terminal having received the PTT IP packets converts those PTT IP packets to a set of moving picture data, which are then separated into voice data and picture data, respectively, by means of a de-multiplexing stage. Then, these voice and picture data sets are respectively delivered to a display unit and a speaker unit in synchronism with each other, for providing image communication to the users.

The above-described PTT image communication system makes it possible to more efficiently suppress occurrence of signal delays between voice and picture as compared to the conventional image communication system, owing to its PTT communication characteristics of performing a unilateral communication and using the PS network 30. Moreover, as compared to the conventional PTT communication system only serving audio, the above PTT image communication system can provide its mobile users with picture as well as voice during a call, thereby giving a great deal of satisfaction to the subscribers.

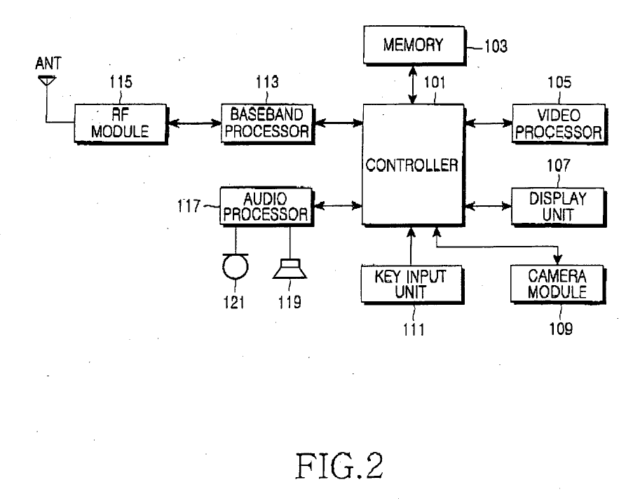

Referring to FIG. 2, a schematic block diagram is shown of a mobile communication terminal carrying out a PTT image communication service according to the present invention. The configuration embodied in the diagram of FIG. 2 is applied to the mobile communication terminals 11, 13 and 15 as shown in FIG. 1. As shown in FIG. 2, the mobile communication terminal according to a preferred embodiment of the invention includes a controller 101, a memory 103, a video processor 105, a display unit 107, a camera module 109, a key input unit 111, a base-band processor 113, an Radio Frequency (RF) module 115, an audio processor 117, a speaker unit 119 and a microphone unit 121.

Referring again to FIG. 2, description is made to the configuration of the mobile terminal. The controller 101 serves to control and execute all the overall functions and operations carried out using the mobile communication terminal such as a telephone call or data communications, etc. The key input unit 111 is provided with a set of numeral keys from “0” through “9”, one or more special character keys such as “*” or “#”, a set of function keys for activation of various functions to be served with the mobile terminal, and a PTT call key, so that predetermined key input data corresponding to a key depression by a user of the mobile terminal are supplied to the controller 101.

The RF module 115 functions to transmit and receive RF signals to and from a base station for mobile communications using an antenna element (ANT), in particular, modulating a transmit signal input from the controller 101 via the base-band processor 113 for transmission of the modulated RF signals at the antenna and demodulating the received RF signals from the antenna to deliver to the controller 101 via the base-band processor 113. Further, the RF module 115 is controlled to receive a paging channel for delivery of system information to the controller 101. The base-band processor 113 serves to process a base-band signal communicated in between the RF module 115 and the controller 101.

The audio processor 117 coupled to the controller 101, and the microphone 121 and the speaker 119 coupled to the audio processor 117 are used for a telephone call and a voice recording using the mobile phone. A series of audio data input from the microphone 121 are converted to a fixed format of voice data through the audio processor 117. For instance, the voice data may be preferably of Adaptive Multi Rate (AMR) format or G.723 standard format. The audio processor 117 outputs the voice data to the speaker unit 119 to reproduce a voice.

The camera module 109 provides outputs of pictorial data generated from image sensors (non shown). The pictorial data output from the camera module 109 is supplied to the video processor 105 under control of the controller 101, wherein the video processor 105 serves to convert the pictorial data to a suitable format of image data, for example, in MPEG4 or H.263 standard format. Then, the controller 101 processes the image data to be provided to the display unit 107 for reproduction of an original picture, wherein the display unit 107 makes a display of various images as well as the above picture data under control of the controller 101.

The memory device 103 is adapted to store control programs for the control of various data processing and operations in the controller 101, a set of reference data for the operations, and various temporarily stored data capable of updating, and/or access numbers for mobile terminals designated for a PTT image communication group call. This memory device also functions as a working memory for the controller 101.

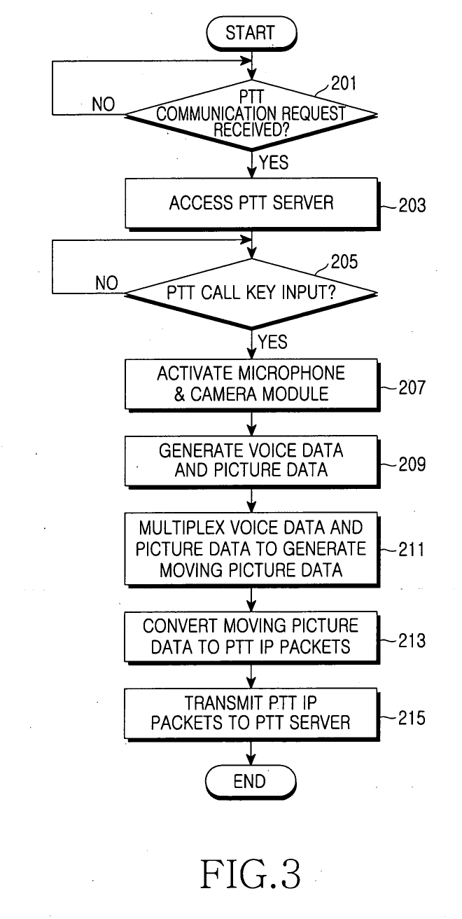

Referring now to a flow chart diagram of FIG. 3, the operation sequence for PTT IP packet transmission in the mobile communication terminal is described for a preferred embodiment of the present invention. The controller 101 proceeds to step 203 once it is determined in step 201 that a PTT communication request has been received, wherein the PTT communication request is made of calling to a predetermined number of PTT communication service. The controller 201 provides access to the PTT server in step 203 and then proceeds to a next step 205. In the step 205, the controller 101 confirms whether an input from PTT call function key has been received, and if such an input is received, then the control proceeds to a next step 207. In the step 207, the controller 101 activates the microphone 121 and the camera module 109 in response to the PTT call key input and then proceeds to a step 209. In the step 209, the controller 101 produces a set of voice and picture data based upon the respective input data received from the microphone 121 and the camera module 109 on an activated state and then proceeds to a next step 211. The controller 101 performs a multiplexing of the voice data and the picture data in the step 211 to produce a stream of moving picture data and subsequently the control proceeds to a next step 213. In the step 213, the controller 101 converts of the moving picture data to a series of PTT IP packet data and then the control proceeds to a next step 215. In the step 215, the controller 101 transfers the PTT IP packet data to the PTT server 40 together with the destination terminal information designated by the user. Control is terminated following the step 215.

The above-described PTT IP packets are delivered to the PTT server 40 via the mobile communication network 20 and the PS network 30, and the PTT server controls PTT IP packet transfer to the destination mobile terminal again via the mobile communication network 20 and the PS network 30.

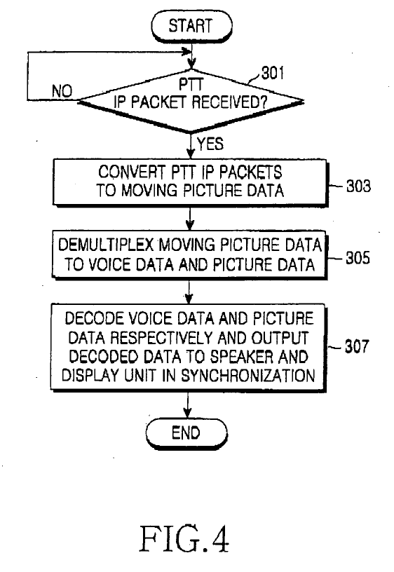

Referring now to FIG. 4, description will be made to the control process for processing the PTT IP packets in the destination mobile communication terminal which received those PTT IP packets. FIG. 4 schematically shows a flow chart diagram of the operation sequence for a PTT IP packet reception in the mobile communication terminal according to the present invention. Accessing the PTT server, the controller 101 checks whether it has been received the PTT IP packets in step 301 and if received, then the control proceeds to a next step 303. In step 303, the controller 101 converts the PTT IP packets to a series of moving picture data and then proceeds to a next step 305. In step 305, the controller 101 performs a demultiplexing of the moving picture data for separation of voice data and picture data and then the control proceeds to a next step 307. In the step 307, the controller 101 respectively decodes these voice and picture data and then outputs the decoded data to the speaker 119 and the display unit 107 for allowing the users to have the picture communications with each other. Following this step, control is terminated.

As understood from the foregoing description, the present invention provides mobile subscribers with the PTT picture communication with one or more designated destination parties, converting a set of voice data and image data to PTT IP packets and transferring the packet data through the PTT communication, thereby allowing its users to implement a stable picture communications system at an economic cost.

While the present invention has been heretofore shown and described with reference to preferred embodiments, it will be understood by those skilled in the art that various changes and modifications in form and details may be made therein and the equivalents may be substituted for elements thereof, without departing from the spirit and scope of the invention as defined by the appended claims.

What is claimed is:

1. A method of performing push-to-talk (PTT) image communication using a mobile communication terminal having at least one camera module, comprising:
accessing a push-to-talk (PTT) server upon receipt of a request from a user of the mobile communication terminal;
activating the camera module and a microphone unit upon input of a PTT call function key to produce picture data and voice data;
multiplexing the picture data and the voice data to generate a set of moving picture data; and
converting the moving picture data to push-to-talk Internet Protocol (PTT IP) packets and transferring the packets to the PTT server.

2. The method according to claim 1, further comprising:
receiving a given PTT IP packet while accessing the PTT server;
converting the PTT IP packet to moving picture data;
demultiplexing the moving picture data to separate a series of voice data and picture data therefrom; and
reproducing the voice data in synchronization to be output to a speaker and simultaneously reproducing the picture data in synchronization to be output to a display unit.

3. A push-to-talk (PTT) image communication system using a mobile communication terminal, comprising:
a push-to-talk (PTT) server for transmitting a push-to-talk Internet protocol (PTT IP) received to a destination mobile terminal; and
the mobile communication terminal including a controller for accessing the PTT server upon receipt of a request from a user of the mobile communication terminal, activating a camera module and a microphone unit upon input of a PTT call function key to thereby produce picture data and voice data, multiplexing the produced picture data and the voice data to generate a set of moving picture data, and converting the moving picture data to the PTT IP packets and transferring the packets to the PTT server.

4. The push-to-talk (PTT) image communications system according to claim 3, wherein the mobile communication terminal controls converting a given received PTT IP packet to a moving picture data while accessing the PTT server, demultiplexing the moving picture data to respectively separate a series of voice data and picture data therefrom, and reproducing the voice data in synchronization to be output to a speaker and simultaneously reproducing the picture data in synchronization to be output to a display unit.
